(19) United States
(12) Patent Application Publication
(10) Pub. No.: US 2017/0254777 A1
(43) Pub. Date: Sep. 7, 2017

(54) METHOD TO IMPROVE THE IDENTIFICATION, QUANTIFICATION AND SPATIAL LOCALIZATION OF MULTIPLY CHARGED MOLECULES IN BIOLOGICAL SAMPLES USING ION MOBILITY INFORMATION

(71) Applicant: Waters Technologies Corporation, Milford, MA (US)

(72) Inventors: Hernando Olivos, Woburn, MA (US); Giuseppe Astarita, Milford, MA (US)

(21) Appl. No.: 15/435,748

(22) Filed: Feb. 17, 2017

Related U.S. Application Data
(60) Provisional application No. 62/297,065, filed on Feb. 18, 2016.

(51) Int. Cl. G01N 27/62; G01N 30/72; H01J 49/00; H01J 49/16

(52) U.S. Cl. CPC G01N 27/622; H01J 49/165; G01N 30/7233; H01J 49/004

(57) ABSTRACT

Described herein is a method of analyzing a sample including molecules having two or more possible sites for ionization comprising: 1) separating ionized molecules of the sample according to ion mobility of the ionized molecules, and 2) analyzing the ionized molecules using mass spectrometry. Additionally described herein is a method of diagnosing and/or determining the progression of a disease or disorder associated with gangliosides and/or cardiolipins in a subject comprising: 1) separating ionized molecules in a biological sample from the subject according to ion mobility of the ionized molecules, and 2) analyzing the ionized molecules using mass spectrometry to identify and quantify gangliosides and/or cardiolipins in the sample.

### REFERENCE TO RELATED APPLICATION

This application claims the benefit of U.S. Provisional Application No. 62/297,065, filed Feb. 18, 2016, the entire contents of which are incorporated herein by reference.

### FIELD

This invention relates generally to a method of using ionization state of certain molecules in a complex sample to isolate, and potentially quantify, individual components therein. In particular, the present disclosure relates to the separation of certain multiply-charged molecules, such as lipids, based on ionization state using ion-mobility (IM) separation followed by mass spectrometry (MS) characterization.

### BACKGROUND

Cellular lipids are very complex, and are typically divided into eight different categories: fatty acyls, glycerolipids, glycerophospholipids, sphingolipids, sterol lipids, prenol lipids, saccharolipids, and polyketides; which are further divided into classes and subclasses of molecules. Each class has its own characteristics and contains many individual species with common features, thus making it hard to differentiate using standard techniques.

Traditional analytical approaches to analyze lipids include shotgun lipidomics, chromatographic-based separation followed by MS detection and ambient ionization-MS. However, because of the chemical complexity of lipid species, these approaches are often associated with the inability to distinguish isobaric species. Thus, there is a need for improved techniques for rapid separation of components from complex mixtures.

### SUMMARY OF THE INVENTION

The use of ion mobility-MS (IM-MS) in combination with traditional lipidomics approaches may significantly increase identification and quantification of lipids by separating lipids in two dimensions according to their mobility times and masses. Mobility times are directly related to the size, the shape, and the charge of the lipid ions. While most of the lipids ionize as singly charged ions, some lipid species can ionize as doubly or multiply charged ions, which makes them easily recognizable by IM-MS when present in complex mixtures

The present disclosure relates to methods for identifying and quantifying certain molecules, such as lipids, based on their ability to form multiple charges when ionized, by separating the components of a sample first based on charge, followed by characterization by mass spectrometry.

In particular, this invention relates to a method of using ionization state of certain molecules in a complex sample to isolate, and potentially quantify, individual components therein. Methods disclosed herein are useful for the identification, quantification, and, optionally, spatial localization of multiply charged lipids, such as gangliosides and cardiolipins. In general, the methods of the present disclosure can allow rapid analysis of biological samples without requiring sample preparation.

In one embodiment, the present disclosure relates to a method of analyzing a sample including molecules having two or more possible sites for ionization comprising: 1) separating ionized molecules of the sample according to the ion mobility of the ionized molecules, and 2) analyzing the ionized molecules using mass spectrometry.

In another embodiment, the present disclosure relates to a method of diagnosing and/or determining the progression of a disease or disorder associated with gangliosides and/or cardiolipins in a subject comprising: 1) separating ionized molecules in a biological sample from the subject according to ion mobility of the ionized molecules, and 2) analyzing the ionized molecules using mass spectrometry to identify and quantify gangliosides and/or cardiolipins in the sample.

The methods of the present disclosure provide several advantages over the prior art. The presently disclosed methodology can be used for determination of lipid content from a sample with improved selectivity, sensitivity, specificity, and/or mass accuracy over current separation techniques. In particular, the methods disclosed herein are useful for the identification, quantification, and spatial localization of molecules which can become multiply charged upon ionization, such as gangliosides and cardiolipins. Use of this method to determine the quantity and location of gangliosides and cardiolipins may be used to diagnose and/or determine the progression of diseases associated with ganglioside and cardiolipin expression, metabolism, storage, composition, and/or catabolism.

The use of IM-MS method described herein advantageously improves the data-independent acquisition process for identifying lipids in complex mixtures. The presently described IM-MS methods may provide up to a five-fold increase in peak capacity, and can increase the accuracy of identification and quantification of individual components in a sample because it allows for identification by accurate mass in addition to their CCS value. By plotting mobility versus mass (as is done during ion mobility separation), it is possible to differentiate lipids from other classes of biomolecules such as peptides, carbohydrates, and oligosaccharides. Lipid classes (e.g., phosphatidylcholines and sphingomyelins) and lipid subclasses (e.g., vinyl ether phosphatidylethanolamines and acyl phosphatidylethanolamines) fall into distinct trend lines on a m/z-mobility plot, facilitating the feature annotation of unknown lipid structures. The observed increase in peak capacity and specificity of analysis ultimately improves lipid fingerprinting and identification as compared to shotgun lipidomics applications.

### BRIEF DESCRIPTION OF THE DRAWINGS

FIG. 1A shows the mass spectrum of total lipids extracted from bovine brain after direct infusion in a IM-MS system.

FIG. 1B shows an ion mobility plot of mass over charge (m/z) versus drift time for molecules carrying a single charge as well as molecules carrying multiple charges.

FIG. 2A shows ionization mobility plots for gangliosides after direct infusion in a IM-MS system.

FIG. 2B shows ionization mobility plots for cholesterol esters after direct infusion in a IM-MS system.

FIG. 2C shows ionization mobility plots for phosphotidylinositols after direct infusion in a IM-MS system.

FIG. 2D shows ionization mobility plots for phosphotidylethanolamines after direct infusion in a IM-MS system.

FIG. 2E shows ionization mobility plots for cerebrosides after direct infusion in a IM-MS system.

FIG. 2G shows ionization mobility plots for phosphatidylcholines after direct infusion in a IM-MS system.

FIG. 2F shows ionization mobility plots for phophatidylserines after direct infusion in a IM-MS system.

FIG. 2H shows ionization mobility plots for cardiolipins after direct infusion in a IM-MS system.

FIG. 2I shows ionization mobility plots for phosphatidyl glycerols after direct infusion in a IM-MS system.

FIG. 3A and FIG. 3B show a magnification of a small area of FIG. 1 (total lipid extract from bovine brain) and the mass spectra of two sections of the plot (below).

FIG. 4 shows a shotgun ion mobility analysis wherein the lipids all carried a single charge. The area labeled FA, denotes fatty acids; the area labeled MG denotes monoacylglycerols; the area labeled DG, denotes diacylglycerols; and the area labeled TG, denotes triacylglycerols.

FIG. 5A shows the MS profile of a heart sample containing cardiolipins;

FIG. 5B shows the ion mobility separation of the components showed in panel A, which allows the isolation of spectra of each component from the driftogram (ions separated by mobility times).

FIG. 6A and FIG. 6D show the separation of singly and doubly charged cardiolipin ions from a heart sample by ion mobility and their characterization by MS.

FIG. 7A and FIG. 7H show gangliosides present in a complex sample and isolated using IM-MS; all the ions showed in the MS spectra above were separated using ion mobility.

FIG. 8A and FIG. 8B show a spectra for a singly charged gangliosides (above) and a doubly charged gangliosides (below); resolution increases along the drift time axis with greater than one charge.

FIG. 9A and FIG. 9H show the separation of gangliosides from a brain sample; the doubly charged ganglioside (1) has a shortened drift time and a tighter resolution than the singly charged counterparts (4) or the impurities (2, 3) in the sample.

FIG. 10A shows a GM1 Tof spectrum DESI ionization.

FIG. 10B shows a GM1 Tof spectrum using MALDI ionization.

FIG. 11A and FIG. 11C show imaging using DESI ionization and separation of components from a brain cross-section to map the spatial localization of various components in the tissue.

FIG. 12A and FIG. 12D show real time analysis of untreated blood spots using DESI: the mass spectra with ion mobility separation prior to MS characterization (top) as compared to the typical shotgun MS analysis (bottom) without ion mobility separation.

### DETAILED DESCRIPTION

This invention relates generally to a method of using ionization state of certain molecules in a complex sample to isolate, and potentially quantify, individual components therein. In particular, the methods disclosed herein are useful for the identification, quantification, and optionally, spatial localization of multiply charged lipids, such as gangliosides and cardiolipins. The methods of the present disclosure can allow rapid analysis of biological samples without requiring sample preparation.

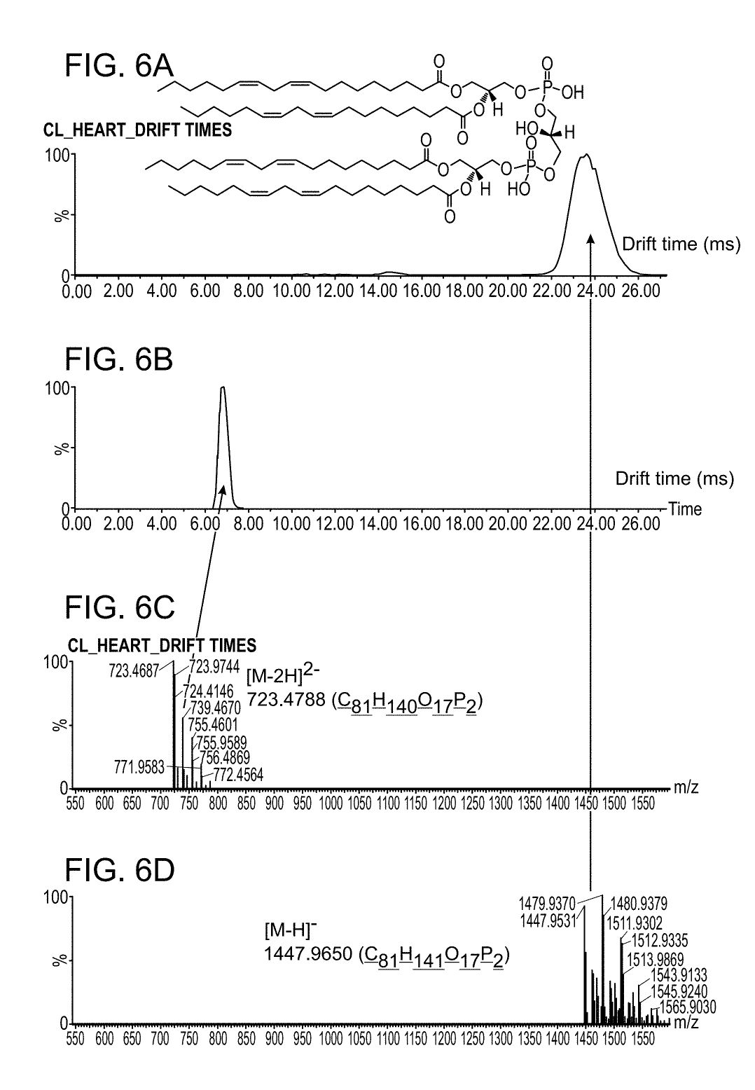

Additionally, the methods, processes, and techniques in accordance to the present disclosure provide a technological advancement with respect to the information obtained in comparison to the prior art (such as shotgun lipidomics). This is clearly seen by the figures, e.g., FIGS. 6A-6D, 7A-7H, and 9A-9H wherein cardiolipins and gangliosides are clearly separated from isobaric species in a complex sample and identified using the IM-MS technique.

### Definitions

Unless stated otherwise, the following terms and phrases as used herein are intended to have the following meanings:

As used herein, the term “isobaric lipid species” refers to a lipid having different chemical elements, but having the same number of nucleons. Correspondingly, such species differ in atomic number (or number of protons) but have the same mass number.

As used herein, the term “biological sample” refers to tissue section, cell culture, plasma, or a dried blood spot. Other biological include but are not limited to: humor, whole blood, serum, umbilical cord blood, cerebrospinal fluid (CSF), saliva, amniotic fluid, breast milk, secretion, ichor, urine, feces, meconium, skin, nail, hair, umbilicus, gastric contents, placenta, bone marrow, peripheral blood lymphocytes (PBL), and solid organ tissue extract. In an exemplary embodiment, the sample is blood, plasma or serum.

As used herein, the term “mass spectrometry” or “MS” refers to an analytical technique to identify compounds by their mass. MS refers to methods of filtering, detecting, and measuring ions based on their mass-to-charge ratio, or “m/z”. MS technology generally includes (1) ionizing the compounds to form charged compounds; and (2) detecting the molecular weight of the charged compounds and calculating a mass-to-charge ratio. The compounds may be ionized and detected by any suitable means. A “mass spectrometer” generally includes an ionizer and an ion detector. In general, one or more molecules of interest are ionized, and the ions are subsequently introduced into a mass spectrometric instrument where, due to a combination of magnetic and electric fields, the ions follow a path in space that is dependent upon mass (“m”) and charge (“z”).

The term “ion-mobility-separation” (“IM”) is a gas-phase electrophoretic technique that enables the separation of gas-phase lipid ions within a chamber pressurized with a buffer gas, such as purified argon or nitrogen gas. An inert gas is not necessarily elemental and is often a compound gas that have the tendency for non-reactivity is due to the valence, the outermost electron shell, being complete in all the inert gases. This is a tendency, not a rule, as noble gases and other “inert” gases can react to form compounds.

As used herein the term “MS^{E}” refers to a method for tandem mass spectrometry data acquisition using alternating low-energy collision-induced dissociation and high-energy collision-induced dissociation where the former is used to obtain precursor ion accurate mass and intensity data for quantification and the latter is used to obtain product ion accurate mass.

As used herein, the term “ionization” or “ionizing” refers to the process of generating an analyte ion having a net electrical charge equal to one or more electron units. Negative ions are those having a net negative charge of one or more electron units, while positive ions are those having a net positive charge of one or more electron units.

As used herein, the term “chromatography” refers to a process in which a chemical mixture carried by a liquid or gas is separated into components as a result of differential distribution of the chemical entities as they flow around or over a stationary liquid or solid phase.

As used herein, the term “liquid chromatography” or “LC” means a process of selective retardation of one or more components of a fluid solution as the fluid uniformly percolates through a column of a finely divided substance, or through capillary passageways. The retardation results from the distribution of the components of the mixture between one or more stationary phases and the bulk fluid, (i.e., mobile phase), as this fluid moves relative to the stationary phase(s). Examples of “liquid chromatography” include reverse phase liquid chromatography (RPLC), high performance liquid chromatography (HPLC), ultra-high performance liquid chromatography (UPLC or UHPLC), turbulent flow liquid chromatography (TFLC) (sometimes known as high turbulence liquid chromatography (HTLC) or high throughput liquid chromatography).

As used herein, the term “high performance liquid chromatography” or “HPLC” (also sometimes known as “high pressure liquid chromatography”) refers to liquid chromatography in which the degree of separation is increased by forcing the mobile phase under pressure through a stationary phase, typically a densely packed column. As used herein, the term “ultra high performance liquid chromatography” or “UPLC” or “UHPLC” (sometimes known as “ultra high pressure liquid chromatography”) refers to HPLC that occurs at much higher pressures than traditional HPLC techniques.

The term “LC/MS” refers to a liquid chromatograph (LC) interfaced to a mass spectrometer (MS).

The term “IM-MS” refers to method that separates gas phase ions on a millisecond timescale using ion-mobility spectrometry and uses mass spectrometry on a microsecond timescale to identify components in a sample.

The term “drift time” refers to the time required for lipid ions to cross the ion-mobility separation cell. This net ion motion is usually much slower than the normally occurring random motion. In a semiconductor the charge carriers will typically have different drift velocities for the same electric field. SI unit of mobility is (m/s)/(V/m)=m2/(V·s). However, mobility is much more commonly expressed in cm²/(V·s)=10⁻⁴ m²/(V·s).

The term “collision cross section” (“CSS”) refers to an area that quantifies the likelihood of a scattering event when an incident species strikes a target species. In a hard object approximation, the cross section is the area of the conventional geometric cross section. The collisional cross sections typically denoted σ and measured in units of area.

### Lipids

Lipids comprise a group of naturally occurring molecules that include fats, waxes, sterols, fat-soluble vitamins (such as vitamins A, D, E, and K), monoglycerides, diglycerides, triglycerides, phospholipids, and others. The main biological functions of lipids include storing energy, signaling, and acting as structural components of cell membranes.

Lipids are broadly defined as hydrophobic or amphiphilic small molecules; the amphiphilic nature of some lipids allows them to form structures such as vesicles, multilamellar/unilamellar liposomes, or membranes in an aqueous environment. Biological lipids originate entirely or in part from two distinct types of biochemical subunits or “building-blocks”: ketoacyl and isoprene groups. Using this approach, lipids may be divided into eight categories: fatty acids, glycerolipids, glycerophospholipids, sphingolipids, saccharolipids, and polyketides (derived from condensation of ketoacyl subunits); and sterol lipids and prenol lipids (derived from condensation of isoprene subunits).

Although the term lipid is sometimes used as a synonym for fats, fats are a subgroup of lipids called triglycerides. Lipids also encompass molecules such as fatty acids and their derivatives (including tri-, di-, monoglycerides, and phospholipids), as well as other sterol-containing metabolites such as cholesterol.

### Fatty Acids

Fatty acids, or fatty acid residues when they are part of a lipid, are a diverse group of molecules synthesized by chain-elongation of an acetyl-CoA primer with malonyl-CoA or methylmalonyl-CoA groups in a process called fatty acid synthesis. They are made of a hydrocarbon chain that terminates with a carboxylic acid group; this arrangement confers the molecule with a polar, hydrophilic end, and a nonpolar, hydrophobic end that is insoluble in water.

The fatty acid structure is one of the most fundamental categories of biological lipids, and is commonly used as a building-block of more structurally complex lipids. The carbon chain, typically between four and 24 carbons long, may be saturated or unsaturated, and may be attached to functional groups containing oxygen, halogens, nitrogen, and sulfur. If a fatty acid contains a double bond, there is the possibility of either a cis or trans geometric isomerism, which significantly affects the molecule's configuration. Cis-double bonds cause the fatty acid chain to bend, an effect that is compounded with more double bonds in the chain. Three double bonds in 18-carbon linolenic acid, the most abundant fatty-acyl chains of plant thylakoid membranes, render these membranes highly fluid despite environmental low-temperatures, and also makes linolenic acid give dominating sharp peaks in high resolution ¹³C NMR spectra of chloroplasts. This in turn plays an important role in the structure and function of cell membranes. Most naturally occurring fatty acids are of the cis configuration, although the trans form does exist in some natural and partially hydrogenated fats and oils.

Examples of biologically important fatty acids include the eicosanoids, derived primarily from arachidonic acid and eicosapentaenoic acid, that include prostaglandins, leukotrienes, and thromboxanes. Docosahexaenoic acid is also important in biological systems, particularly with respect to sight. Other major lipid classes in the fatty acid category are the fatty esters and fatty amides. Fatty esters include important biochemical intermediates such as wax esters, fatty acid thioester coenzyme A derivatives, fatty acid thioester ACP derivatives and fatty acid carnitines. The fatty amides include N-acyl ethanolamines, such as the cannabinoid neurotransmitter anandamide.

### Glycerolipids

Glycerolipids are composed of mono-, di-, and tri-substituted glycerols,[16] the best-known being the fatty acid triesters of glycerol, called triglycerides. The word “triacylglycerol” is sometimes used synonymously with “triglyceride”. In these compounds, the three hydroxyl groups of glycerol are each esterified, typically by different fatty acids. Because they function as an energy store, these lipids comprise the bulk of storage fat in animal tissues. The hydrolysis of the ester bonds of triglycerides and the release of glycerol and fatty acids from adipose tissue are the initial steps in metabolizing fat.

Additional subclasses of glycerolipids are represented by glycosylglycerols, which are characterized by the presence of one or more sugar residues attached to glycerol via a glycosidic linkage. Examples of structures in this category are the digalactosyldiacylglycerols found in plant membranes and seminolipid from mammalian sperm cells.

Glycerophospholipids

Glycerophospholipids, usually referred to as phospholipids, are ubiquitous in nature and are key components of the lipid bilayer of cells, as well as being involved in metabolism and cell signaling. Neural tissue (including the brain) contains relatively high amounts of glycerophospholipids, and alterations in their composition has been implicated in various neurological disorders. Glycerophospholipids may be subdivided into distinct classes, based on the nature of the polar headgroup at the sn-3 position of the glycerol backbone in eukaryotes and eubacteria, or the sn-1 position in the case of archaebacteria.

Examples of glycerophospholipids found in biological membranes are phosphatidylcholine (also known as PC, GPCho or lecithin), phosphatidylethanolamine (PE or GPEtn), and phosphatidylserine (PS or GPSer). In addition to serving as a primary component of cellular membranes and binding sites for intra- and intercellular proteins, some glycerophospholipids in eukaryotic cells, such as phosphatidylinositols and phosphatidic acids are either precursors of or, themselves, membrane-derived second messengers. Typically, one or both of these hydroxyl groups are acylated with long-chain fatty acids, but there are also alkyl-linked and 1Z-alkenyl-linked (plasmalogen) glycerophospholipids, as well as dialkylether variants in archaebacteria.

Sphingolipids

Sphingolipids are a complicated family of compounds that share a common structural feature, a sphingoid base backbone that is synthesized de novo from the amino acid serine and a long-chain fatty acyl CoA, then converted into ceramides, phosphosphingolipids, glycosphingolipids and other compounds. The major sphingoid base of mammals is commonly referred to as sphingosine. Ceramides (N-acyl-sphingoid bases) are a major subclass of sphingoid base derivatives with an amide-linked fatty acid. The fatty acids are typically saturated or mono-unsaturated with chain lengths from 16 to 26 carbon atoms.

The major phosphosphingolipids of mammals are sphingomyelins (ceramide phosphocholines), whereas insects contain mainly ceramide phosphoethanolamines and fungi have phytoceramide phosphoinositols and mannose-containing headgroups. The glycosphingolipids are a diverse family of molecules composed of one or more sugar residues linked via a glycosidic bond to the sphingoid base. Examples of these are the simple and complex glycosphingolipids such as cerebrosides and gangliosides.

Sterol Lipids

Sterol lipids, such as cholesterol and its derivatives, are an important component of membrane lipids, along with the glycerophospholipids and sphingomyelins. The steroids, all derived from the same fused four-ring core structure, have different biological roles as hormones and signaling molecules. The eighteen-carbon (C18) steroids include the estrogen family whereas the C19 steroids comprise the androgens such as testosterone and androsterone. The C21 subclass includes the progestogens as well as the glucocorticoids and mineralocorticoids. The secosteroids, comprising various forms of vitamin D, are characterized by cleavage of the B ring of the core structure. Other examples of sterols are the bile acids and their conjugates, which in mammals are oxidized derivatives of cholesterol and are synthesized in the liver. The plant equivalents are the phytosterols, such as β-sitosterol, stigmasterol, and brassicasterol; the latter compound is also used as a biomarker for algal growth. The predominant sterol in fungal cell membranes is ergosterol.

Prenol Lipids

Prenol lipids are synthesized from the five-carbon-unit precursors isopentenyl diphosphate and dimethylallyl diphosphate that are produced mainly via the mevalonic acid (MVA) pathway. The simple isoprenoids (linear alcohols, diphosphates, etc.) are formed by the successive addition of C5 units, and are classified according to number of these terpene units. Structures containing greater than 40 carbons are known as polyterpenes. Carotenoids are important simple isoprenoids that function as antioxidants and as precursors of vitamin A. Another biologically important class of molecules is exemplified by the quinones and hydroquinones, which contain an isoprenoid tail attached to a quinonoid core of non-isoprenoid origin. Vitamin E and vitamin K, as well as the ubiquinones, are examples of this class. Prokaryotes synthesize polyprenols (called bactoprenols) in which the terminal isoprenoid unit attached to oxygen remains unsaturated, whereas in animal polyprenols (dolichols) the terminal isoprenoid is reduced.

Saccharolipids

Saccharolipids describe compounds in which fatty acids are linked directly to a sugar backbone, forming structures that are compatible with membrane bilayers. In the saccharolipids, a monosaccharide substitutes for the glycerol backbone present in glycerolipids and glycerophospholipids. The most familiar saccharolipids are the acylated glucosamine precursors of the Lipid A component of the lipopolysaccharides in Gram-negative bacteria. Typical lipid A molecules are disaccharides of glucosamine, which are derivatized with as many as seven fatty-acyl chains. The minimal lipopolysaccharide required for growth in E. coli is Kdo2-Lipid A, a hexa-acylated disaccharide of glucosamine that is glycosylated with two 3-deoxy-D-manno-octulosonic acid (Kdo) residue.

Polyketides

Polyketides are synthesized by polymerization of acetyl and propionyl subunits by classic enzymes as well as iterative and multimodular enzymes that share mechanistic features with the fatty acid synthases. They comprise a large number of secondary metabolites and natural products from animal, plant, bacterial, fungal and marine sources, and have great structural diversity. Many polyketides are cyclic molecules whose backbones are often further modified by glycosylation, methylation, hydroxylation, oxidation, and/or other processes. Many commonly used anti-microbial, anti-parasitic, and anti-cancer agents are polyketides or polyketide derivatives, such as erythromycins, tetracyclines, avermectins, and antitumor epothilones.

Methods of the Invention

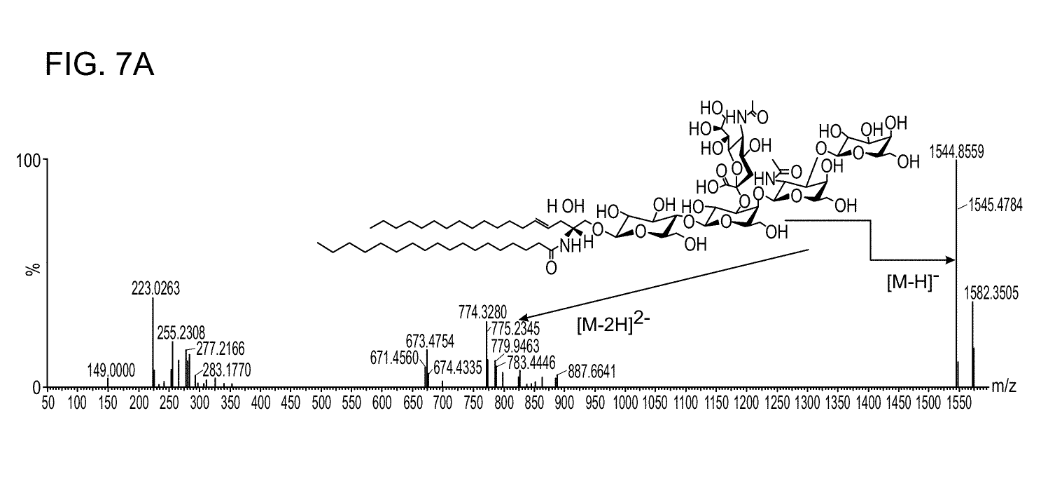

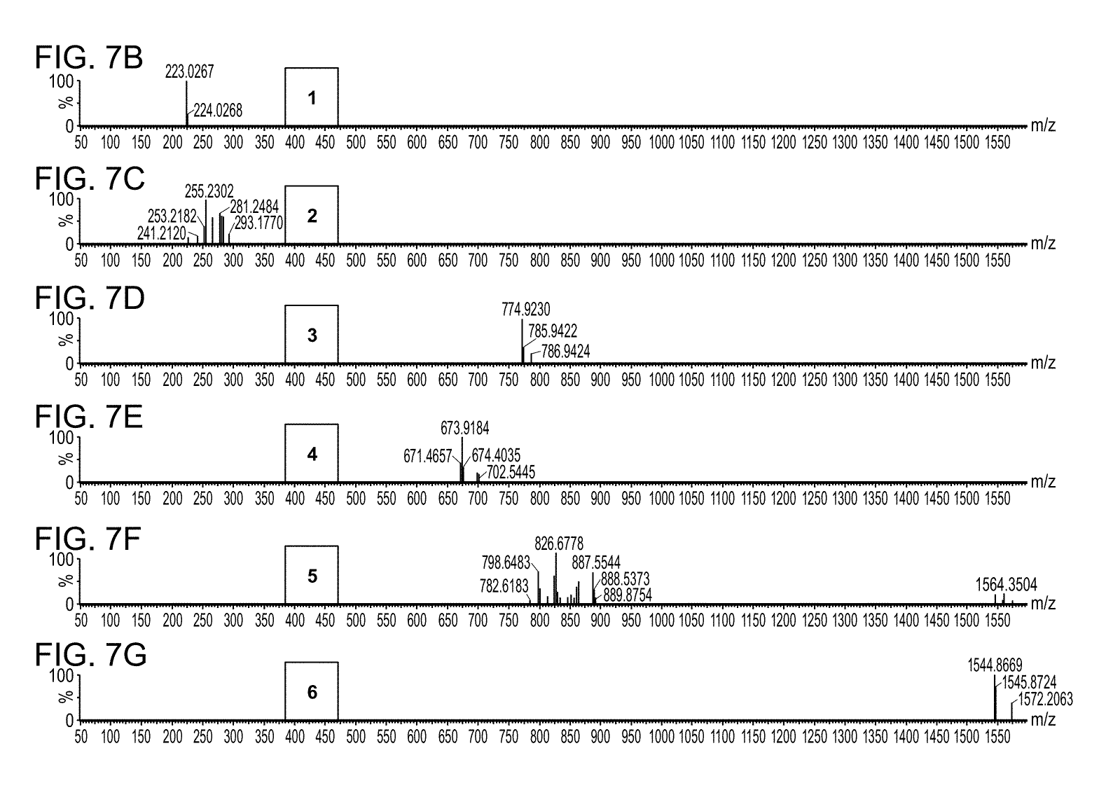

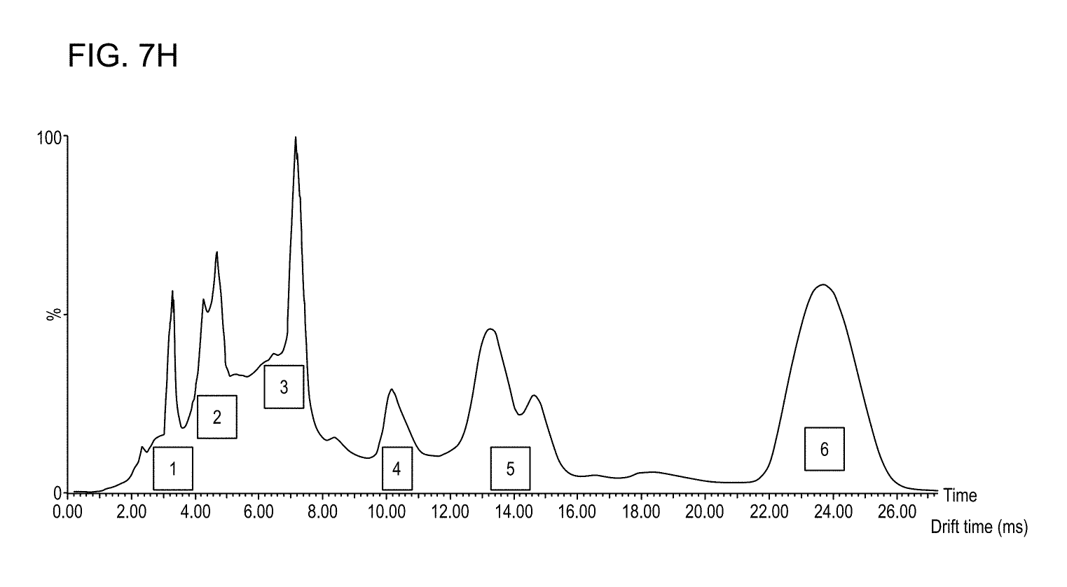

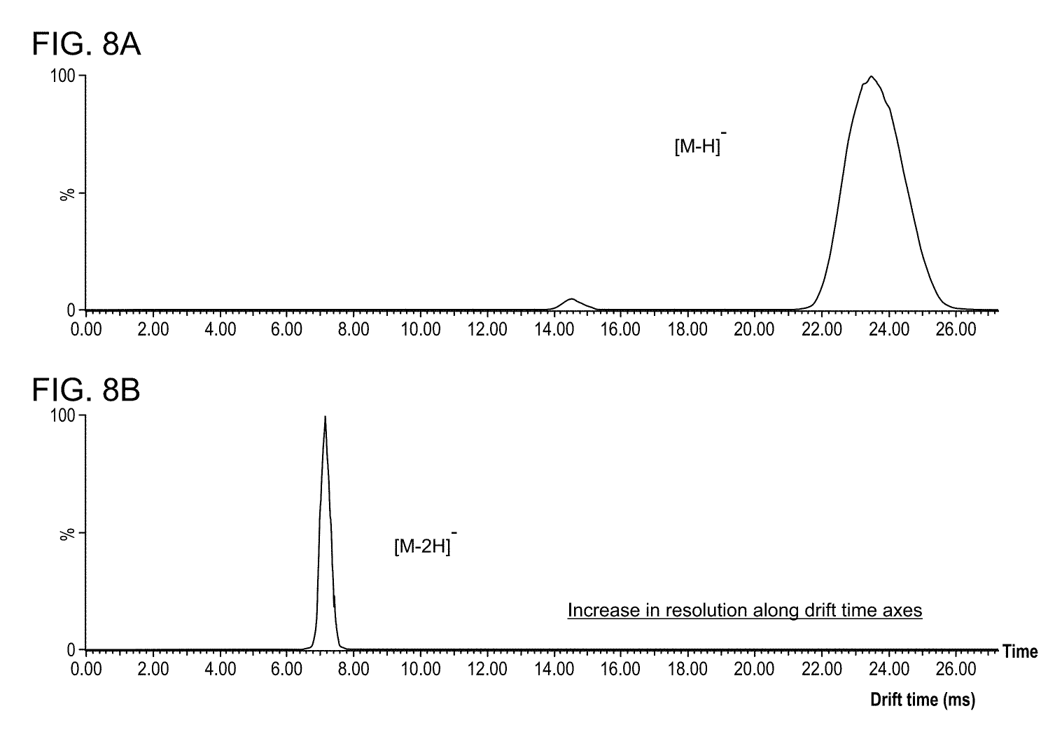

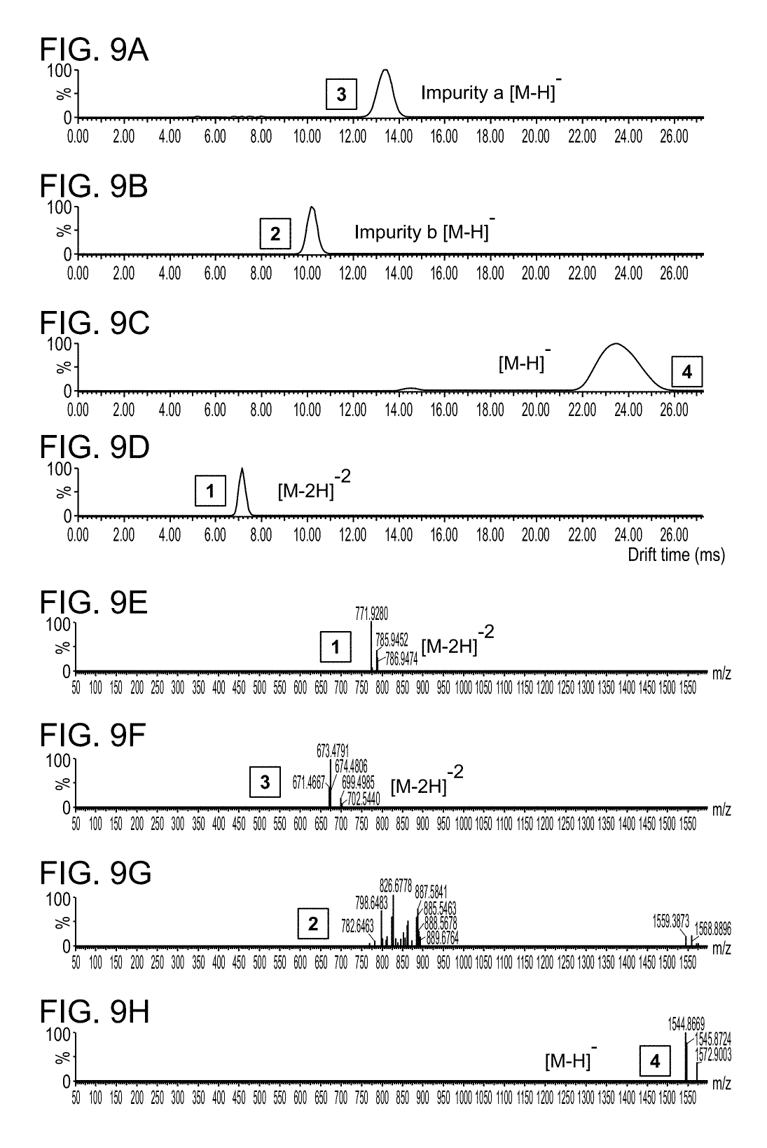

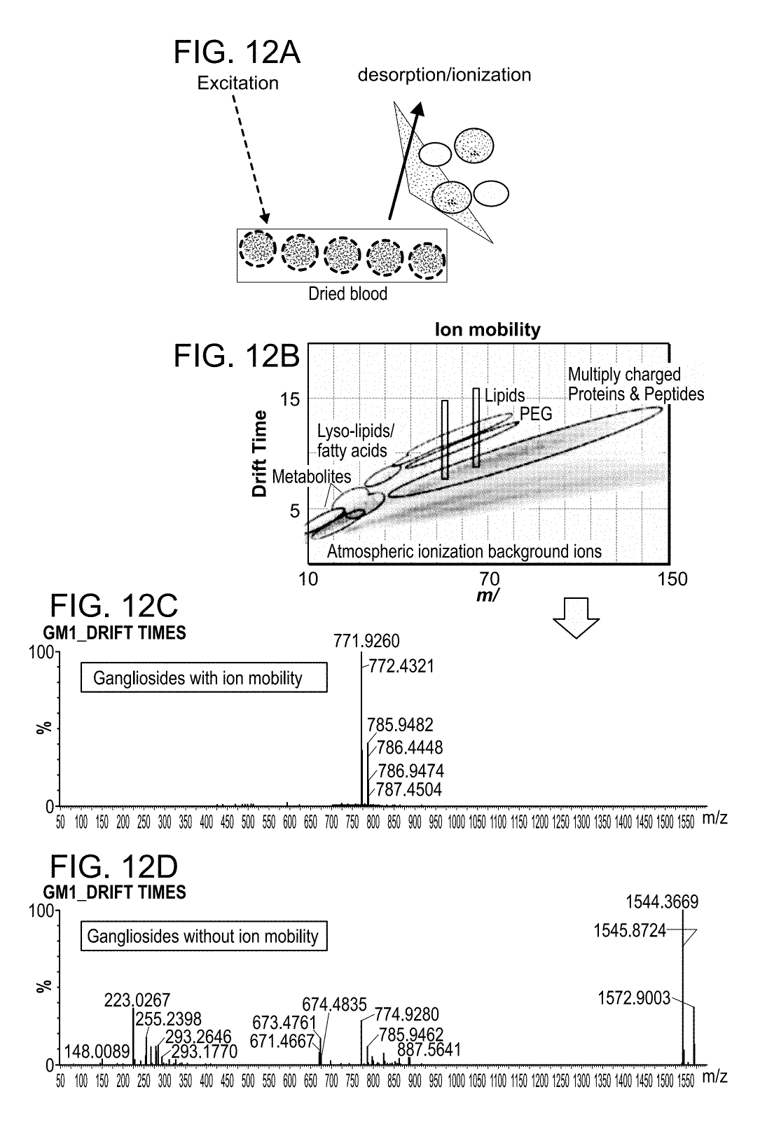

The present methodology capitalizes on the charge potential of certain molecules (e.g., lipids such as gangliosides and cardiolipins) in a biological sample which have two or more possible sites for ionization. It allows a crude sample to have its components be first separated based on charge status using ion mobility separation, and then characterized by MS (see, e.g., FIG. 7A-7H). Use of ion mobility technology coupled to MS allows for much greater accuracy and specificity, as is clearly shown by the cross-section maps (FIG. 12A-12D). Thus, the present methodology can separate out isobaric species with different charge status from a sample, unlike traditional lipidomics techniques, including chromatographic separation coupled with MS and direct analysis MS (shotgun lipidomics and in situ lipidomics). In one embodiment, the present disclosure includes separation of components of a sample based on charge state using ion mobility (IM) techniques. The drift time depends principally on the collision frequency between the ions and the buffer gas. Accordingly, drift times are directly related to the shape, size, and charge of the lipid ions as well as to the nature of the buffer gas. For example, in FIG. 8A-8B singly charged gangliosides (above) and a doubly charged gangliosides (below); resolution increases along the drift time axis with greater than one charge. FIG. 9A-9H demonstrate that the doubly charged ganglioside (1) has a shortened drift time and a tighter resolution than the singly charged counterparts (4) or the impurities (2, 3) in the sample. Given the weight of the components, standard shotgun lipidomics using just MS wouldn't be able to distinguish the individual species in the sample.

From the characteristic time that a lipid ion takes to cross the ion mobility separation cell (drift time), it is possible to calculate the rotationally-averaged collision cross section (CCS), which represents the effective area for the interaction between an individual ion and the neutral gas through which it travels. CCS, an important physicochemical property of a lipid species, is related to chemical structure and three-dimensional conformation.

Collision cross section values are derived from ion mobility measurements. All of the first order equations governing ion mobility apply at low electric fields. Uniform field drift tube designs typically operate at low electric field resulting in very predictable and accurate mobility measurements. Conventional uniform field drift tube ion mobility provides a direct method to calculate collision cross sections (W) using the Mason-Schamp equation given below:

$$Ω = \frac{{( 18 π )}^{1 \text{/} 2}}{16} {\frac{ze}{{( {k}_{b} T )}^{1 \text{/} 2}} [ \frac{1}{{m}_{I}} + \frac{1}{{m}_{B}} ]}^{1 \text{/} 2} \frac{{t}_{d} E}{L} \frac{760}{P} \frac{T}{273.2} \frac{1}{N}$$

where Ω is the rotationally averaged collision cross section, k_{b} is the Boltzman constant, T is the temperature of the buffer gas, m₁ is the mass of analyte ion, m_{B} is the mass of buffer gas molecules, t_{d} is the corrected drift time, ze is the charge state of the analyte ion, E is the electric field, L is the length of the drift cell, P is the pressure in drift cell, and N is the number density in the drift cell. It is important to note that t_{d} can be determined from the total ion drift time. Once t_{d} values are calculated they can be used to directly generate CCS measurements.

The accuracy to which the collision cross section can be calculated is determined by the extent to which experimental parameters (pressure, temperature and electric field) are maintained during the mobility experiment. Any time the ion spends outside of the defined drift region produces “end effects,” which cause loss of measurement accuracy. Measurements of CCS within 2% accuracy or less can be routinely achieved using uniform field drift tubes.

In one embodiment, the present disclosure relates to use of drift time ion mobility spectrometry (DT-IMS), traveling wave ion mobility spectrometry (TW-IMS), or differential mobility spectrometry (DMS), which is also known as field-asymmetric ion-mobility spectrometry (FAIMS) for the separation of ionized molecules of a sample according to the ion mobility of the ionized molecules. In one aspect of this embodiment, the ionized molecules are separated according to ion mobility based on the charge state of the ionized molecules, e.g., by mass spectrometry.

In one embodiment, the present method includes the additional step of ionizing the molecules in the biological sample to be analyzed prior to the separation of the ionized molecules of the sample according to the ion mobility and analyzing the separated ionized molecules using mass spectrometry. In one aspect of this embodiment, the ionization step must have the ability to ionize at least two or more potential sites of ionization on the molecules in a sample. In one aspect of this embodiment, the ionization may be achieved using electrospray ionization (ESI) or desorption electrospray ionization (DESI). In one aspect of this embodiment, the ionization step includes electrospray ionization (ESI).

### Mass Spectrometry

Mass spectrometry (MS) is an analytical technique that measures the mass-to-charge ratio of a charged molecule or molecule fragments formed from a sample. MS is used to analyze the mass, chemical composition, and/or chemical structure of a component in a sample of interest. In general, MS includes three steps: ionizing a sample to form charged molecules or molecule fragments (i.e., ions); separating the ions based on their mass-to-charge ratio; and detecting the separated ions to form a mass-to-charge signal (i.e., spectra).

A variety of mass spectrometry systems capable of high mass accuracy, high sensitivity, and high resolution are known in the art and can be employed in the methods of the invention. The mass analyzers of such mass spectrometers include, but are not limited to, quadrupole (Q), time of flight (TOF), ion trap, magnetic sector, or FT-ICR or combinations thereof. The ion source of the mass spectrometer should yield mainly sample molecular ions, or pseudo-molecular ions, and certain characterizable fragment ions. Examples of such ion sources include atmospheric pressure ionization sources, e.g. electrospray ionization (ESI) and Matrix Assisted Laser Desorption Ionization (MALDI). ESI and MALDI are the two most commonly employed methods to ionize proteins for mass spectrometric analysis. ESI and APC1 are the most commonly used ion source techniques for LC/MS (Lee, M. “LC/MS Applications in Drug Development” (2002) J. Wiley & Sons, New York).

Surface Enhanced Laser Desorption Ionization (SELDI) is an example of a surface-based ionization technique that allows for high-throughput mass spectrometry (U.S. Pat. No. 6,020,208). Typically, SELDI is used to analyze complex mixtures of proteins and other biomolecules. SELDI employs a chemically reactive surface such as a “protein chip” to interact with analytes, e.g., proteins, in solution. Such surfaces selectively interact with analytes and immobilize them thereon. Thus, the analytes of the invention can be partially purified on the chip and then quickly analyzed in the mass spectrometer. By providing different reactive moieties at different sites on a substrate surface, throughput may be increased.

Commercially available mass spectrometers can sample and record the whole mass spectrum simultaneously and with a frequency that allows enough spectra to be acquired for a plurality of constituents in the mixture to ensure that the mass spectrometric signal intensity or peak area is quantitatively representative. This will also ensure that the elution times observed for all the masses would not be modified or distorted by the mass analyzer and it would help ensure that quantitative measurements are not compromised by the need to measure abundances of transient signals.

Accordingly. in one embodiment, the present method includes use of any type of mass spectrometer. In one aspect of this embodiment, the present method includes analysis of the separated ionized molecules after ion mobility separation using sector, time-of-flight, quadrupole, ion trap, or Fourier transform ion cyclotron resonance, or by tandem mass spectrometry (MS/MS) (where two or more of the above types are combined in tandem or orthogonally). In one embodiment, the present disclosure includes analysis of the separated ionized molecules after ion mobility separation is done using tandem mass spectrometry (MS/MS).

Lipids localize in different compositions and concentrations across the surface of biological samples. MS imaging allows topographic mapping of the lipid content of e.g., cell cultures and tissue sections. In a typical IM-MS imaging experiment, a focused excitatory beam (e.g., laser or a stream of charged solvent droplets) is directed at the biological sample to scan the surface along a user defined two dimensional array. Upon impact of the excitatory beam, biomolecular ions are desorbed and ionized from the sample surface and directed into the mass spectrometer. The addition of IM to a typical MS imaging experiment allows separation of the lipid ions of interest from the interfering background before MS detection, resulting in a greater signal-to-noise ratio and more accurate lipid localization.

In one embodiment, the present disclosure includes analyzing a sample including molecules having two or more possible sites for ionization at a plurality of locations, comprising separating ionized molecules of the sample according to ion mobility of the ionized molecules, and analyzing the ionized molecules using mass spectrometry sampling a plurality of different locations on the sample and obtaining mass spectral data corresponding to each location sampled. In one aspect of this embodiment, the data collected by the method for each location is used to determine the spatial localization of molecules in the sample. In one aspect of this embodiment, the biological sample is a tissue section or a cell culture.

Advantages of the present method include the ability to obtain real-time, high-throughput analysis of the lipid components of a biological sample, such as dried blood spots, biofluids and tissue-biopsies, without performing any sample preparation. The presently disclosed methodology can be used for determination of lipid content from a sample with improved selectivity, sensitivity, specificity, and/or mass accuracy over current separation techniques, while maintaining the ability to rapidly analyze samples.

Additional advantages of separating multiply charged ions out of solution first by separation by charge status includes increasing resolution (i.e., the ability to distinguish two peaks of slightly different mass-to-charge ratios ΔM, in a mass spectrum), easier separation of target components from impurities based on their differing mass-to-charge ratio, and shorter drift-times of doubly charged ions versus singly charged ions. See, e.g., FIGS. 6A-6D, FIGS. 7A-7H, FIGS. 8A-8B, and FIGS. 9A-9H.

In another embodiment, the method of the present disclosure may be performed by incorporation ion mobility separation into the Waters Technologies Corporation MS^{E} process (for example, processes capable with using Xevo® GS-XS QTof, SYNAPT® G2-Si MS, Vion® IMS QTof, all commercially available from Waters Technologies Corporation, Milford, Mass.). Use of this process for the present method allows an acquisition mode, high definition MS (HDMSE), where co-eluting lipid precursor ions can be separated by ion-mobility before fragmentation, resulting in cleaner MS/MS product-ion spectra. In aspect of this embodiment, the method includes the calculation of the CCS (nm²⁻) value for the ionized molecules. In a further aspect of this embodiment, the CCS value calculated in the present method is used to assist in the identification of components of the sample. Similar to accurate mass, the experimental CCS value of each detected lipid can be search against CCS databases to support lipid identification. Such databases include, e.g., The Waters Metabolic CCS Library (available for download at http://nonlinear.com/progenesis/qi/v2.2/faq/compound-search-metabolic-profiling.aspx), The McLean Collision Cross Section Database (http://www.vanderbilt.edu/AnS/Chemistry/groups/mcleanlab/ccs.html), and others.

Further, various desorption ionization techniques have been combined with IM-MS for imaging of lipids, including MALDI, DESI, and LAESI. In one embodiment, the present disclosure includes the additional step of ionizing the molecules in the biological sample to be analyzed prior to the separation of the ionized molecules of the sample according to the ion mobility of the ionized molecules, wherein the ionization step is done using desorption electrospray ionization or laser ablation electrospray ionization.

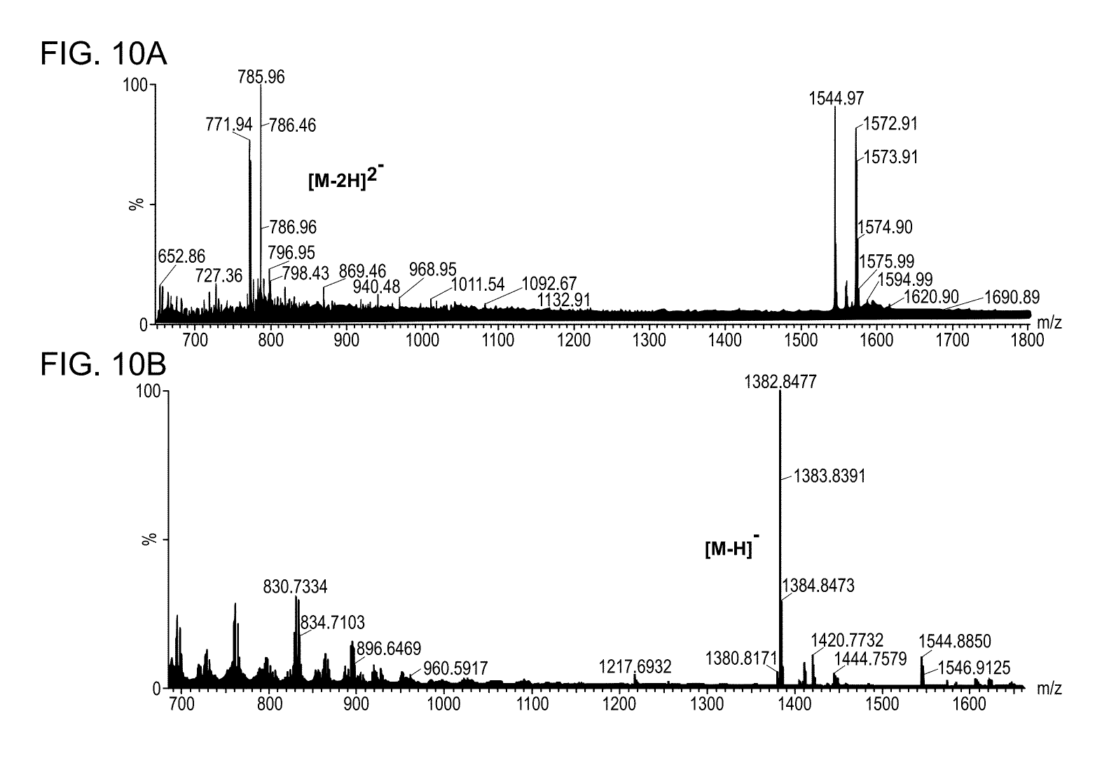

In one embodiment, the ionization step is performed using MALDI (FIG. 10A). However, MALDI does not induce formation of multiply charged ions, gangliosides cannot be easily distinguished from other isobaric species. Thus, in another embodiment, the ionization step is performed using DESI (FIG. 10B).

### Optical Spectroscopy

A variety of optical spectroscopy systems capable of high accuracy, high sensitivity, and high resolution are known in the art and can be employed in the methods of the invention. Absorption spectroscopy refers to optical spectroscopic techniques that measure the absorption of radiation, as a function of frequency or wavelength, due to its interaction with a sample. The sample absorbs energy, i.e., photons, from the radiating field. The intensity of the absorption varies as a function of frequency, and this variation is the absorption spectrum. Absorption spectroscopy is performed across the electromagnetic spectrum.

Absorption spectroscopy is employed as an analytical chemistry tool to determine the presence of a particular substance in a sample and, in many cases, to quantify the amount of the substance present. Infrared and ultraviolet-visible spectroscopy are particularly common in analytical applications.

There are a wide range of experimental approaches for measuring absorption spectra. The most common arrangement is to direct a generated beam of radiation at a sample and detect the intensity of the radiation that passes through it. The transmitted energy can be used to calculate the absorption. The source, sample arrangement and detection technique vary significantly depending on the frequency range and the purpose of the experiment.

The most straightforward approach to absorption spectroscopy is to generate radiation with a source, measure a reference spectrum of that radiation with a detector and then re-measure the sample spectrum after placing the material of interest in between the source and detector. The two measured spectra can then be combined to determine the material's absorption spectrum. The sample spectrum alone is not sufficient to determine the absorption spectrum because it will be affected by the experimental conditions—the spectrum of the source, the absorption spectra of other materials in between the source and detector and the wavelength dependent characteristics of the detector. The reference spectrum will be affected in the same way, though, by these experimental conditions and therefore the combination yields the absorption spectrum of the material alone.

A wide variety of radiation sources can be employed in order to cover the electromagnetic spectrum. For spectroscopy, it is generally desirable for a source to cover a broad swath of wavelengths in order to measure a broad region of the absorption spectrum. Some sources inherently emit a broad spectrum. Examples of these include globars or other black body sources in the infrared, mercury lamps in the visible and ultraviolet and x-ray tubes. One recently developed, novel source of broad spectrum radiation is synchrotron radiation which covers all of these spectral regions. Other radiation sources generate a narrow spectrum but the emission wavelength can be tuned to cover a spectral range. Examples of these include klystrons in the microwave region and lasers across the infrared, visible and ultraviolet region (though not all lasers have tunable wavelengths).

The detector employed to measure the radiation power will also depend on the wavelength range of interest. Most detectors are sensitive to a fairly broad spectral range and the sensor selected will often depend more on the sensitivity and noise requirements of a given measurement. Examples of detectors common in spectroscopy include heterodyne receivers in the microwave, bolometers in the millimeter-wave and infrared, mercury cadmium telluride and other cooled semiconductor detectors in the infrared, and photodiodes and photomultiplier tubes in the visible and ultraviolet.

UV/Visible Spectroscopy

“Ultraviolet/visible spectroscopy” refers to absorption spectroscopy or reflectance spectroscopy in the ultraviolet (UV) and/or visible electromagnetic spectral region. Ultraviolet (UV) electromagnetic radiation can have a wavelength ranging from 100 nm (30 PHz) to 380 nm (750 THz), shorter than that of visible light but longer than X-rays. The visible light is a type of electromagnetic radiation that is visible to the human eye. Visible electromagnetic radiation can have a wavelength ranging from about 390 nm (430 THz) to about 700 nm (770 THz).

The instrument used in ultraviolet-visible spectroscopy is called a UV/Vis spectrophotometer. It measures the intensity of light passing through a sample (I), and compares it to the intensity of light before it passes through the sample (I₀). The ratio I/I₀ is called the transmittance, and is usually expressed as a percentage (% T). The absorbance, A, is based on the transmittance:

Fluorescence Spectroscopy

“Fluorescence spectroscopy” refers to a type of electromagnetic spectroscopy that analyzes fluorescence from a sample. It involves using a beam of light, usually ultraviolet light, that excites the electrons in molecules of certain compounds and causes them to emit light; typically, but not necessarily, visible light. A complementary technique is absorption spectroscopy. In the special case of single molecule fluorescence spectroscopy, intensity fluctuations from the emitted light are measured from either single fluorophores, or pairs of fluorophores.

Two general types of instruments exist: (1) filter fluorometers that use filters to isolate the incident light and fluorescent light; and (2) spectrofluorometers that use a diffraction grating monochromators to isolate the incident light and fluorescent light. Both types use the following scheme: the light from an excitation source passes through a filter or monochromator, and strikes the sample. A proportion of the incident light is absorbed by the sample, and some of the molecules in the sample fluoresce. The fluorescent light is emitted in all directions. Some of this fluorescent light passes through a second filter or monochromator and reaches a detector, which is usually placed at 90° to the incident light beam to minimize the risk of transmitted or reflected incident light reaching the detector.

Various light sources may be used as excitation sources, including lasers, LED, and lamps; xenon arcs and mercury-vapor lamps in particular. A laser only emits light of high irradiance at a very narrow wavelength interval, typically under 0.01 nm, which makes an excitation monochromator or filter unnecessary. A mercury vapor lamp is a line lamp, meaning it emits light near peak wavelengths. By contrast, a xenon arc has a continuous emission spectrum with nearly constant intensity in the range from 300-800 nm and a sufficient irradiance for measurements down to just above 200 nm.

Filters and/or monochromators may be used in fluorimeters. A monochromator transmits light of an adjustable wavelength with an adjustable tolerance. The most common type of monochromator utilizes a diffraction grating, that is, collimated light illuminates a grating and exits with a different angle depending on the wavelength. The monochromator can then be adjusted to select which wavelengths to transmit. For allowing anisotropy measurements the addition of two polarization filters are necessary: One after the excitation monochromator or filter, and one before the emission monochromator or filter.

As mentioned above, the fluorescence is most often measured at a 90° angle relative to the excitation light. This geometry is used instead of placing the sensor at the line of the excitation light at a 180° angle in order to avoid interference of the transmitted excitation light. No monochromator is perfect and it will transmit some stray light, that is, light with other wavelengths than the targeted. An ideal monochromator would only transmit light in the specified range and have a high wavelength-independent transmission. When measuring at a 90° angle, only the light scattered by the sample causes stray light. This results in a better signal-to-noise ratio, and lowers the detection limit by approximately a factor 10000, when compared to the 180° geometry. Furthermore, the fluorescence can also be measured from the front, which is often done for turbid or opaque samples.

The detector can either be single-channeled or multichanneled. The single-channeled detector can only detect the intensity of one wavelength at a time, while the multichanneled detects the intensity of all wavelengths simultaneously, making the emission monochromator or filter unnecessary. The different types of detectors have both advantages and disadvantages.

The most versatile fluorimeters with dual monochromators and a continuous excitation light source can record both an excitation spectrum and a fluorescence spectrum. When measuring fluorescence spectra, the wavelength of the excitation light is kept constant, preferably at a wavelength of high absorption, and the emission monochromator scans the spectrum. For measuring excitation spectra, the wavelength passing though the emission filter or monochromator is kept constant and the excitation monochromator is scanning. The excitation spectrum generally is identical to the absorption spectrum as the fluorescence intensity is proportional to the absorption.

### Samples

In general, a sample used in the methods described herein is a composition known or suspected to contain one or more lipids. Samples can include a solid, liquid, gas, mixture, material (e.g., of intermediary consistency, such as a, extract, cell, tissue, organisms) or a combination thereof. In various embodiments, the sample is a biological sample, an environmental sample, a food sample, a synthetic sample, an extract (e.g., obtained by separation techniques), or a combination thereof.

Biological samples can include any sample that is derived from the body of a subject. In this context, the subject can be an animal, for example a mammal, for example a human. Other exemplary subjects include a mouse, rat, guinea-pig, rabbit, cat, dog, goat, sheep, pig, cow, or horse. The individual can be a patient, for example, an individual suffering from a disease or being suspected of suffering from a disease. A biological sample can be a bodily fluid or tissue, for example taken for the purpose of a scientific or medical test, such as for studying or diagnosing a disease (e.g., by detecting and/or identifying a pathogen or the presence of a biomarker). Biological samples can also include cells, for example, pathogens or cells of the individual biological sample (e.g., tumor cells). Such biological samples can be obtained by known methods including tissue biopsy (e.g., punch biopsy) and by taking blood, bronchial aspirate, sputum, urine, feces, or other body fluids. Exemplary biological samples include humor, whole blood, plasma, serum, umbilical cord blood (in particular, blood obtained by percutaneous umbilical cord blood sampling (PUBS)), cerebrospinal fluid (CSF), saliva, amniotic fluid, breast milk, secretion, ichor, urine, feces, meconium, skin, nail, hair, umbilicus, gastric contents, placenta, bone marrow, peripheral blood lymphocytes (PBL), and solid organ tissue extract.

In one embodiment, the sample is a blood sample, such as a dried blood spot. In another embodiment, the sample is a blood-derived sample, such as plasma or serum.

In another embodiment, the sample is a cell sample. The cell sample can contain material obtained or derived from a subject. In other embodiments, the cell sample can contain cells from an in vitro or ex vivo cell culture. In other embodiments, the sample is a cell supernatant sample.

While it is recognized that the majority of samples used in the methods described herein will be biological samples, samples derived from other sources known or suspected to contain one or more lipids may also be used in the disclosed methods. Such other samples include environmental samples, which may contain one or more lipids due to, for example, the intentional or unintentional contamination of a given natural or manmade environment. Alternatively, other samples may include synthetic samples, which may contain one or more lipids as a result of, for example, an industrial process.

Environmental samples can include any sample that is derived from the environment, such as the natural environment (e.g., seas, soils, air, and flora) or the manmade environment (e.g., canals, tunnels, buildings). Such environmental samples can be used to discover, monitor, study, control, mitigate, and avoid environmental pollution. Exemplary environmental samples include water (e.g., drinking water, river water, surface water, ground water, potable water, sewage, effluent, wastewater, or leachate), soil, air, sediment, biota (e.g., soil biota), flora, fauna (e.g., fish), and earth mass (e.g., excavated material).

Synthetic samples can include any sample that is derived from an industrial process. The industrial process can be a biological industrial process (e.g., processes using biological material containing genetic information and capable of reproducing itself or being reproduced in a biological system, such as fermentation processes using transfected cells) or a non-biological industrial process (e.g., the chemical synthesis or degradation of a compound such as a pharmaceutical). Synthetic samples can be used to check and monitor the progress of the industrial process, to determine the yield of the desired product, and/or measure the amount of side products and/or starting materials.

### Methods of Diagnosing/Determining Disease Progression

Gangliosides are a class of glycosphingolipid comprising a variety of related structures composed of an oligosaccharide chain anchored to a hydrophobic ceramide base, and are identified by the presence of at least one sialic acid in their sugar chain. The central nervous system contains high concentrations of gangliosides where they participate in cell to cell interactions and regulate cell proliferation, differentiation and signaling. In addition, gangliosides bind specifically to viruses and to various bacterial toxins, such as those from botulinum, tetanus and cholera, and they mediate interactions between microbes and host cells during infections.

Alterations in storage and catabolism of gangliosides in tissues lead to a series of lipidoses, including Tay-Sachs disease and Sandhoff disease related to accumulation of GM2 gangliosidoses, GM1 gangliosidosis and acute inflammatory disorders such as Guillain-Barre syndrome. Gangliosides are also involved in pathological states such as cancer, as they may accumulate in tumors but not in normal healthy tissues. Impaired ganglioside metabolism is also relevant to Alzheimer's disease, Huntington's disease, and a human autosomal recessive infantile-onset epilepsy syndrome. In contrast, some gangliosides are believed to have a neuroprotective role in certain types of neuronal injury, Parkinsonism, and some related diseases. See, e.g., Xu et al., “Multi-system Disorders of Glycosphingolipid and Glanglioside Metabolism”, J. Lipid Res. (2010) 51(7):1643-1675. Thus, the ability to accurately identify and quantify the presence or absence of gangliosides from a sample can be useful for diagnosing or determining the degree of severity of a disease associated with gangliosides.

Cardiolipins are phospholipids having four acyl groups and potentially carrying two negative charges. They are found almost exclusively in certain membranes of bacteria and of mitochondria of eukaryotes where they are essential for the function of enzymes which are involved in mitochondrial energy metabolism. Barth syndrome is associated with marked abnormalities in the composition of cardiolipin. The consequence may be a reduction in the efficiency of oxidative phosphorylation in mitochondria or an increase in the permeability of the mitochondrial membranes.

In addition, alterations in the concentrations of cardiolipins or changes in its composition in heart mitochondria have been implicated in many different human diseases states, including heart failure, diabetes and cancer. Malfunctions of cardiolipin metabolism in brain mitochondria have been implicated in Alzheimer's disease and Parkinson's disease. Antibodies to cardiolipin in plasma of patients with bacterial infection (e.g., syphilis) and with various diseases in which tissue damage occurs is considered to be a danger signal to the immune system. Antibodies to cardiolipin are used in diagnostic tests after venous or arterial thrombotic episodes or miscarriages. Thus, the ability to accurately identify and quantify the presence or absence of cardiolipins from a sample can be useful for diagnosing or determining the degree of severity of a disease associated with cardiolipins.

Some of the major challenges for the measurement of gangliosides and cardiolipins include the high degree of chemical complexity and the wide range of concentrations. Additionally, lipid identification by MS and detection may be affected by the presence of isobaric species and background noise from biological matrices. Thus, there is a clear need for improved methods of identifying and quantifying gangliosides and cardiolipins more accurately than is available currently.

In one embodiment, the present disclosure includes a method of diagnosing and/or determining the progression of a disease or disorder associated with gangliosides and/or cardiolipins in a subject comprising: 1) separating ionized molecules in a biological sample from the subject according to ion mobility of the ionized molecules, and 2) analyzing the ionized molecules using mass spectrometry to identify and quantify gangliosides and/or cardiolipins in the sample.

In one embodiment of the present method, the disease or disorder is associated with impaired ganglioside metabolism, or altered ganglioside storage and/or catabolism. In one aspect of this embodiment, the disease or disorder is selected from Tay-Sachs disease, Sandhoff disease, Guillain-Barre syndrome, Alzheimer's disease, Huntington's disease and human autosomal recessive infantile-onset epilepsy syndrome.

In one embodiment of the method, the disease or disorder is associated with abnormal composition of cardiolipins or alterations of the concentration of cardiolipins in cells. In one aspect of this embodiment, the disease or disorder is selected from Barth syndrome, heart failure, diabetes and cancer.

In any of these embodiments, the sample may be infused directly into the instrument used for ion mobility-based separation.

In one embodiment, the present disclosure includes separation of components of a sample based on charge state using ion mobility (IM) techniques. In one embodiment, the present disclosure relates to use of drift time ion mobility spectrometry (DT-IMS), traveling wave ion mobility spectrometry (TW-IMS), or differential mobility spectrometry (DMS), which is also known as field-asymmetric ion-mobility spectrometry (FAIMS) for the separation of ionized molecules of a sample according to the ion mobility of the ionized molecules. In one aspect of this embodiment, the ionized molecules are separated according to ion mobility based on the charge state of the ionized molecules. Since cardiolipins and gangliosides have two sites for ionization, they can be easily isolated using ionization mobility separation from all other lipid species which have a different charge state, including isobaric species which have, for example, only a single point of potential ionization.

In another embodiment, the present method includes the additional step of ionizing the molecules in the biological sample to be analyzed prior to the separation of the ionized molecules of the sample according to the ion mobility of the ionized molecules and analyzing the separated ionized molecules using mass spectrometry. In one aspect of this embodiment, the ionization step must have the ability to ionize at least two or more potential sites of ionization on the molecules in a sample. In one aspect of this embodiment, the ionization may be achieved using electrospray ionization (ESI) or desorption electrospray ionization (DESI). In one aspect of this embodiment, the ionization step includes electrospray ionization.

In yet another embodiment, the present method includes the additional step of separating the molecules in a biological sample using chromatography prior to the separation of ionized molecules of the sample according to the ion mobility of the ionized molecules and analyzing the separated ionized molecules using mass spectrometry. In a further embodiment, the present method includes the steps of: 1) separation of a biological sample by chromatography; 2) ionizing the molecules isolated after the chromatography step; 3) separating the ionized molecules of the sample according to the ion mobility of the ionized molecules; and 4) analyzing the ionized molecules using mass spectrometry. In any of the above embodiments, the separation of the biological sample by chromatography includes separation by gas chromatography or liquid chromatography. In one aspect of this embodiment, the separation of the biological sample is done using liquid chromatography, wherein the liquid chromatography is selected from ultra-high performance liquid chromatography (UHPLC), high performance liquid chromatography (HPLC), hydrophilic interaction chromatography (HILIC), and supercritical fluid chromatography (SFC). Even the most advanced chromatographic technique alone cannot completely separate the wide array of lipids in biological samples, but because chromatographic separations occur in seconds and IM separations in milliseconds, IM can be coupled to chromatography. The resulting method may provide an additional degree of separation and will result in increased specificity of lipid identification and relative quantification.

In still another embodiment, the present disclosure relates to calculating a collisional cross section (CCS) value for the ionized molecules, wherein the CCS value assigned for each molecule assists in the identification of the components of the sample. In addition to accurate mass, the experimental CCS of each detected lipid ion, such as for gangliosides and/or cardiolipins, can be searched against CCS databases, to support lipid identification.

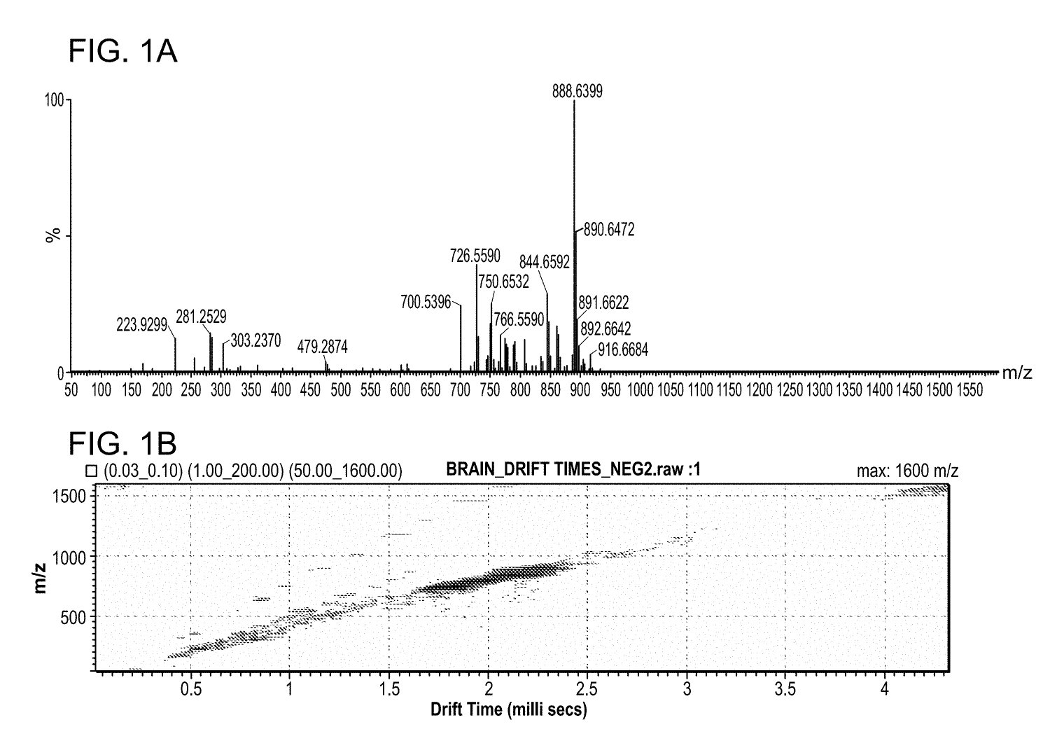

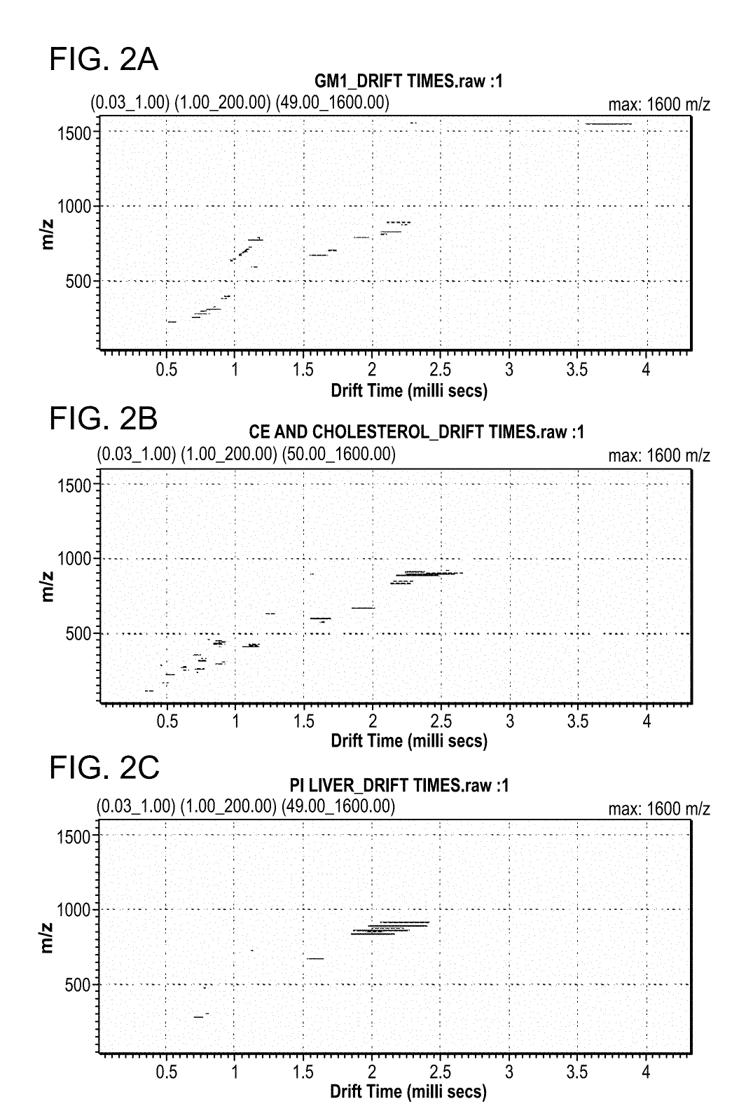

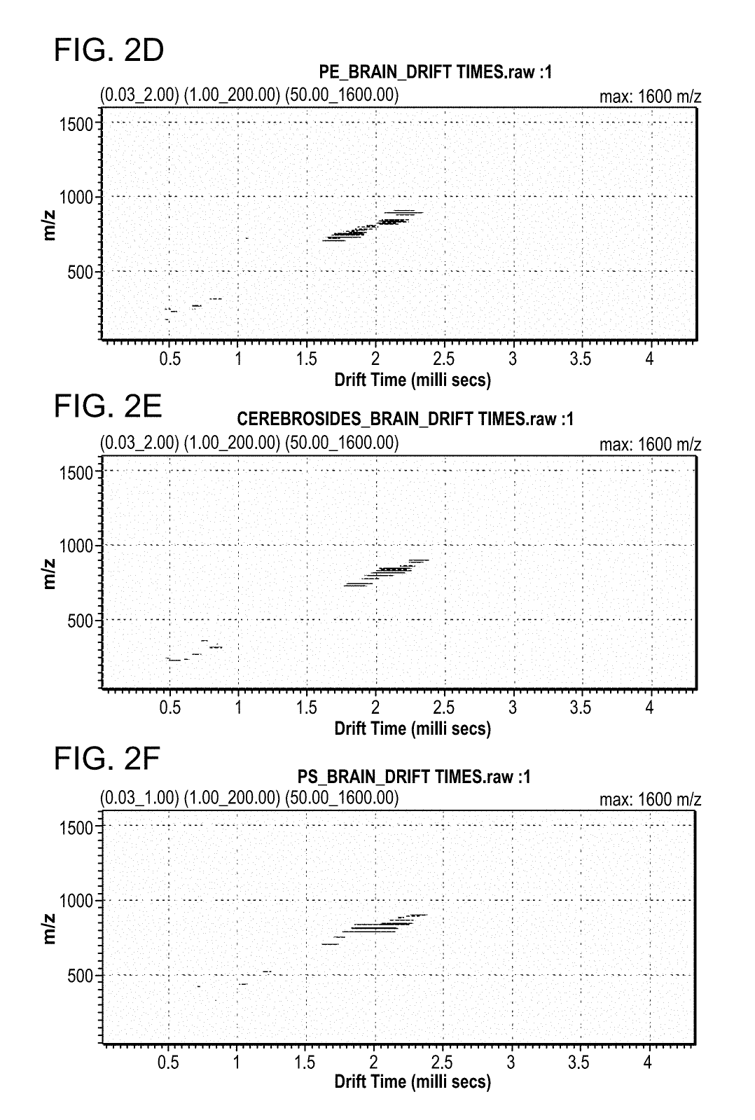

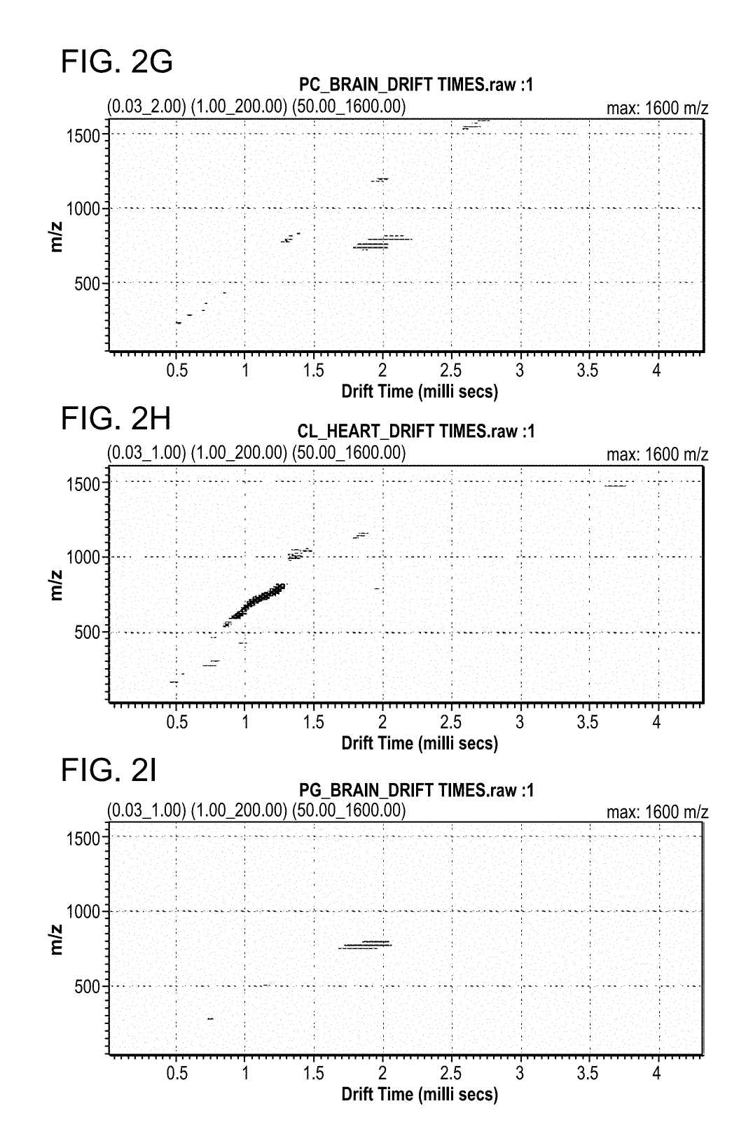

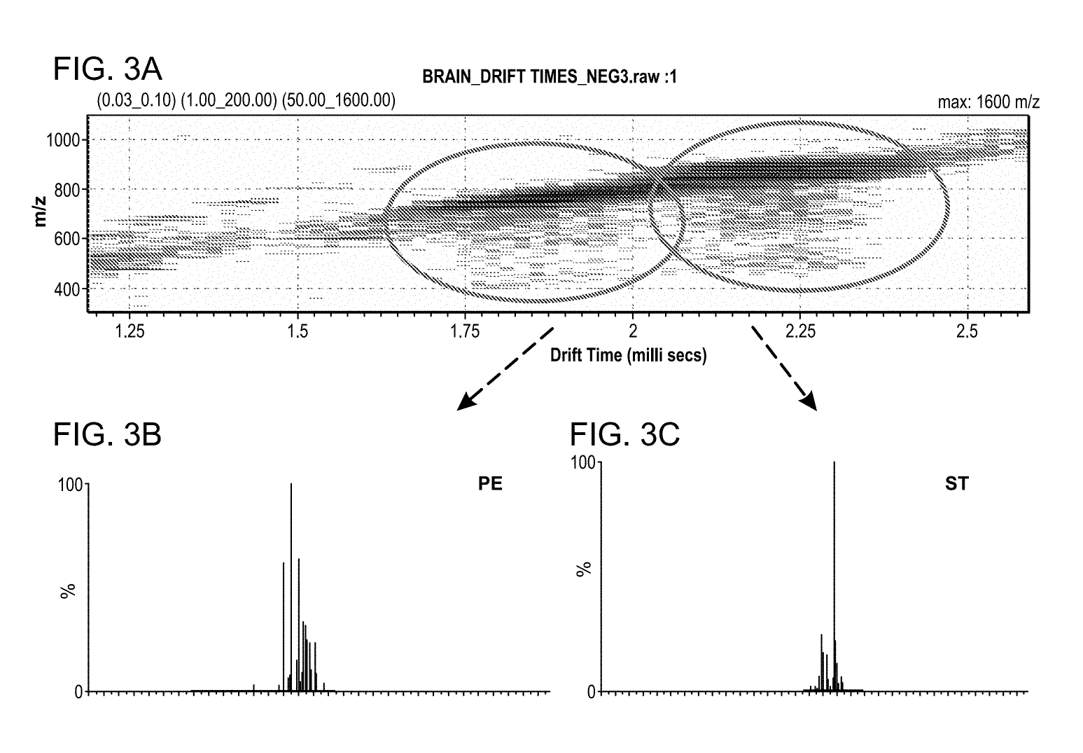

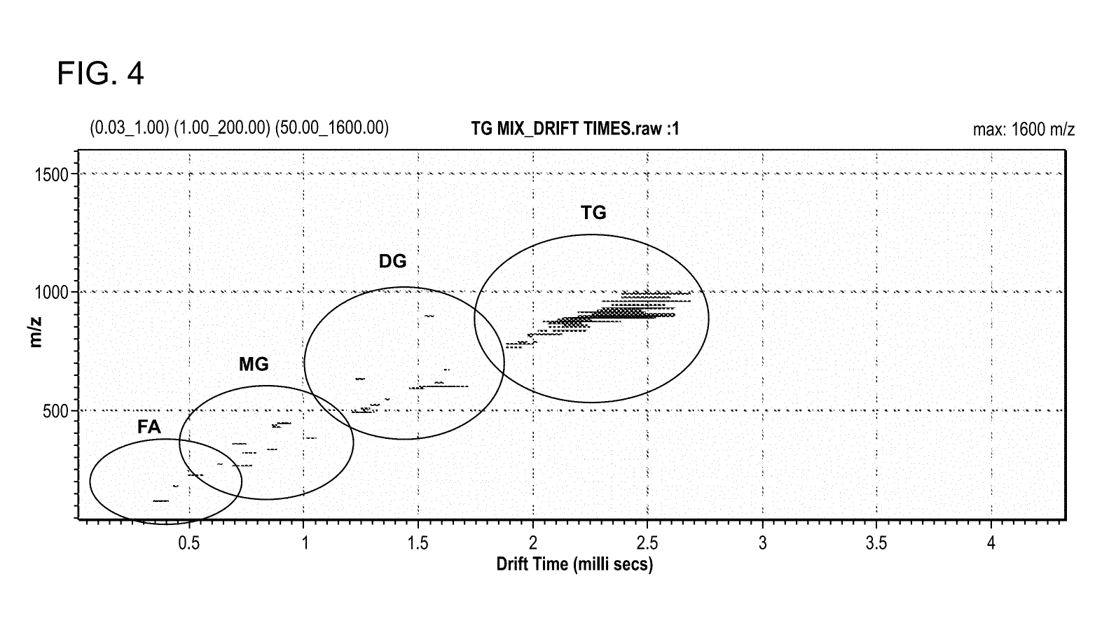

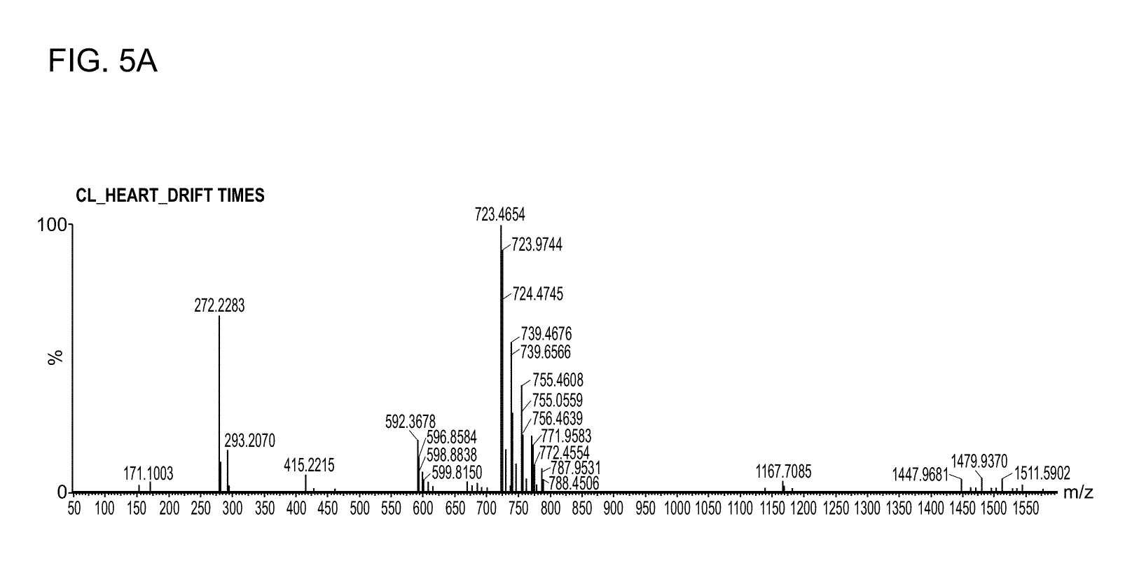

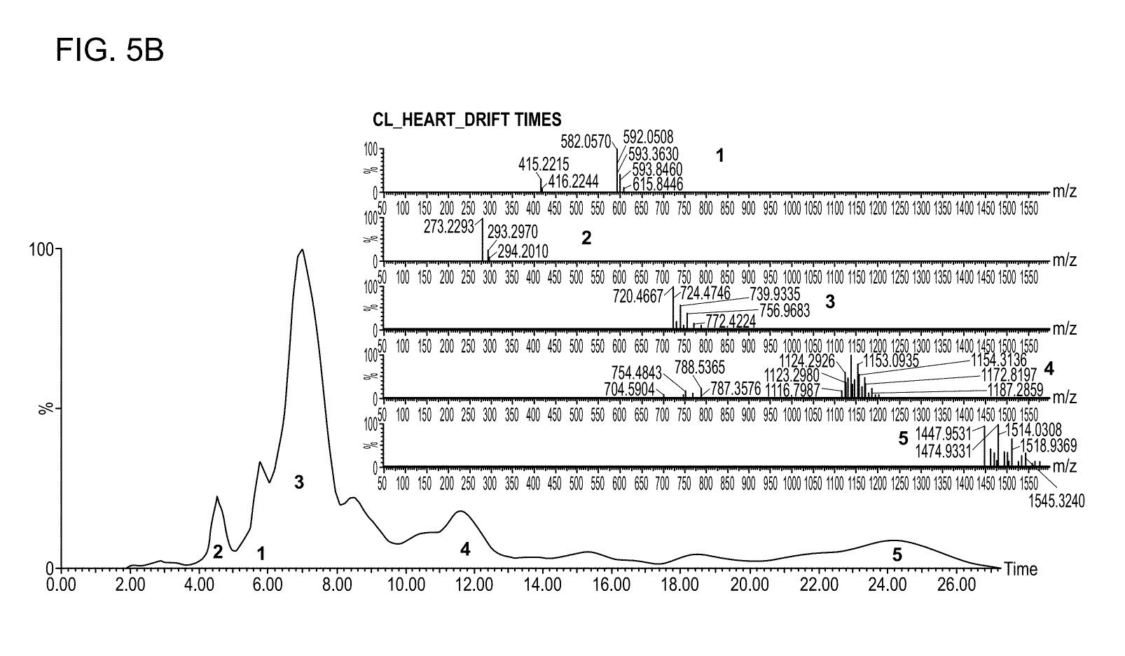

In another embodiment, the present disclosure relates to separation of isobaric lipid species from a biological sample based on the charge state of the ionized molecules by first separating the ionized lipids according to the ion mobility of the ionized lipids, and then analyzing the ionized molecules using mass spectrometry. FIG. 1B shows the mass spectrum of total lipids extracted from bovine brain after direct infusion in a IM-MS system, which demonstrates that that most molecules carry a single charge, whereas the few that carry multiple charges, follow different trend lines. Moreover, the lipids in FIGS. 2B-2G and 2I can only attain a single charge under standard ionization conditions.

In one aspect of this embodiment, the biological sample includes one or more isobaric lipids which can be separated using ion mobility based on differential charge status—meaning one isobaric species has two or more possible sites for ionization (i.e., gangliosides and/or cardiolipins), while the other isobaric species has a different number of possible sites for ionization, such as one, and the ion mobility separation step is able to separate out the isobaric species based on charge status. In one aspect of this embodiment, the biological sample includes at least one ganglioside and/or cardiolipin lipid, which both contain two sites of ionization.

### INCORPORATION BY REFERENCE

The contents of all references, patents and published patent applications cited throughout this application, as well as the Figures, are hereby incorporated by reference in their entirety.

### EXAMPLES

### Example 1

FIG. 10B shows analysis of a sample using MALDI-TOF MS (WATERS®) using WATERS® High Definition Imaging Software (HDI) 1.35. Tof experiments were conducted with Ion Mobility Separation (IMS). A small aliquot of sample was placed on the target and them covered with matrix (5-chloro-2-mercaptobenzothiazole (CMBT) which was dissolved in CHCl₃/Et0H/H₂O (4/4/.2/1) at 5 mg/mL). Red phosphorus was used to calibrate the Tof from 200 to 2000 m/z and was also used as a lockmass to adjust the calibration during the imaging experiment. GM1 and GM2 standards provided were spiked together on to the glass slide as controls to monitor IMS drift time (dT). The MS was performed in negative ion mode with scan time set at 0.5 sec/pixel, MS resolution at 10,000, IMS wave velocity at 800 m/s, spatial resolution of 100 μm and a laser frequency of 1000 Hz. As the MALDI ionization was not able to generate multiply charged ions, separation of lipids which have more than one potential ionization site did not occur.

### Example 2

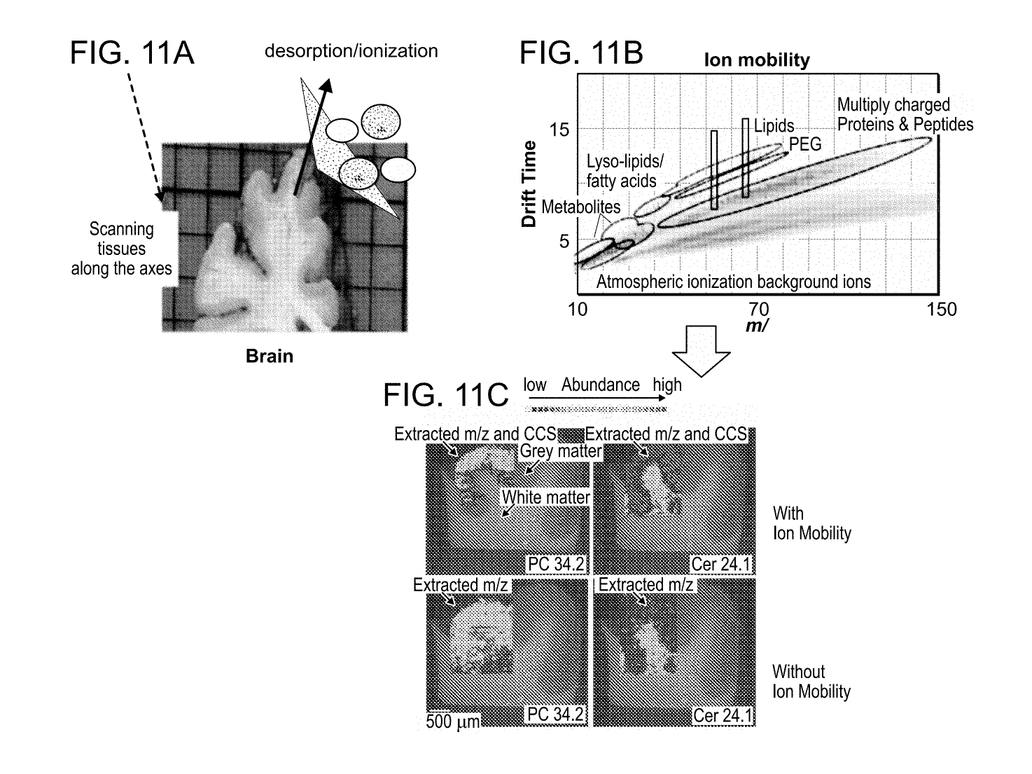

Ionization sources based on electropspray (ESI), including DESI and LAESI, yields multiply charged ions. To exploit the use of CCS information of multiple charged ions to improve MS-imaging applications, human brain samples were analyzed using LAESI coupled to a IM-MS instrument. See FIGS. 11A-11C. Using CCS information allowed for the isolation of lipids from metabolites, multiply charged proteins and peptides, and from the background ions associated with atmospheric ionization. Identities of 93 lipid species were confirmed using a combination of mass and CCS measurements. FIGS. 11A and 11B. Topographical maps representing the lipid ion distribution in sub-regions of the human brain were created for selected mass and CCS values present in grey matter and white matter. The use of ion mobility allowed the spatial separation of isobaric lipid species with different CCS values, improving the quality of the signal-to-noise ratio. Notably, only by using this approach was it possible to determine the selective spatial localization of gangliosides in the grey matter versus white matter. These results indicate that CCS information of multiple charged ions may be a significant tool supporting lipid identification and localization in MS imaging studies. See FIG. 11C, which clearly shows that use of the IM-MS methodology of the present disclosure leads to greatly enhanced accuracy and precision for measuring the spatial localization of components in tissue cross sections.

### Example 3

FIG. 12A-12D shows a direct analysis of gangliosides from dried blood spots (DBS) by DESI. Imaging was done using a [insert name of machine] (WATERS®) equipped with a 2D-DESI source. Data was generated and analyzed using WATERS® High Definition Imaging Software (HDI) 1.35. Spray conditions were as follows: flow rate of 1 μL/min, with a 98% methanol in water mixture at 100 psi N2 gas pressure and a voltage of 5 kV for both polarities. The scan time was 1 second. Gangliosides and cardiolipins (not shown) were separated out as doubly charged ion species, which allowed them to be isolated using ion mobility against interfering ions.

1. A method of analyzing a sample including lipids having two or more possible sites for ionization comprising:
1) separating ionized molecules of the sample according to ion mobility of the ionized molecules, and
2) analyzing the ionized molecules using mass spectrometry.

2. The method of claim 1, wherein the ionized molecules are separated according to ion mobility based on the charge state of the ionized molecules.

3. The method of claim 1, wherein the lipid is a gangliosides or a cardiolipins.

4. The method of claim 1 wherein the ion mobility-based separation includes drift-time ion mobility spectrometry, travelling-wave ion mobility spectrometry, or differential mobility spectrometry.

5. The method of claim 1, further comprising an ionization step, wherein the ionization includes electrospray ionization (ESI) or a desorption ionization technique.

6. The method of claim 5, wherein the ionization step includes electrospray ionization.

7. The method of claim 1, further comprising a step of separating the molecules using chromatography.

8. The method of claim 7, wherein the chromatography includes liquid chromatography or gas chromatography (GC).

9. The method of claim 8, wherein the liquid chromatography is selected from ultra high performance liquid chromatography (UHPLC), high performance liquid chromatography (HPLC), hydrophilic interaction chromatography (HILIC), and supercritical fluid chromatography (SFC)

10. The method of claim 9, wherein the chromatography step occurs prior to the separation of ions based on their ion mobility.

11. The method of claim 1, further comprising sampling a plurality of different locations on the sample and obtaining mass spectral data corresponding to each location.

12. The method of claim 11, wherein the sample is a tissue section or a cell culture.

13. The method of claim 1, wherein the sample is plasma.

14. The method of claim 13, wherein the sample is a dried blood spot.

15. The method of claim 11, wherein the sampling at a plurality of different locations provides spatial location information for molecules in the sample.

16. The method of claim 1, wherein the mass spectrometry includes tandem mass spectrometry (MS/MS).

17. The method of claim 1, further comprising calculating a collisional cross section (CCS) in the identification of components of the sample.

18. The method of claim 1, wherein the sample is infused directly into the instrument used for ion mobility-based separation.

19. The method of claim 1, wherein the sample includes one or more isobaric lipids and the ion mobility step separates lipids having two or more possible sites for ionization.

20. A method of diagnosing or determining the progression of a disease or disorder associated with gangliosides or cardiolipins in a subject comprising separating ionized molecules in a biological sample from the subject according to ion mobility of the ionized molecules, and analyzing the ionized molecules using mass spectrometry to identify and quantify gangliosides or cardiolipins in the sample.

21-37. (canceled)
